(19) United States
(12) Patent Application Publication
(10) Pub. No.: US 2025/0286499 A1
(43) Pub. Date: Sep. 11, 2025

(54) FASTENING TOOL AND FASTENING DEVICE

(71) Applicant: TAKASHIMA & CO., LTD., Tokyo (JP)

(72) Inventor: Masaki Kishimoto, Anjyo-shi (JP)

(73) Assignee: TAKASHIMA & CO., LTD., Tokyo (JP)

(21) Appl. No.: 19/216,476

(22) Filed: May 22, 2025

Related U.S. Application Data
(63) Continuation of application No. PCT/JP2022/044254, filed on Nov. 30, 2022.

(51) Int. Cl. H02S 20/23; F16B 5/00

(52) U.S. Cl. CPC H02S 20/23; F16B 5/0068

(57) ABSTRACT

A fastening tool to mount a plate-shaped photovoltaic module to a mounting target object, includes: a support member arranged on the mounting target object and including a pair of vertical wall portions and a pair of mounting portions formed at upper ends of the vertical wall portions and mounting the photovoltaic module thereon; a pressing member arranged between the pair of vertical wall portions and including a base portion fastened to the mounting target object by a fastening member via the support member, and a regulating portion provided at the base portion and regulating movement of the photovoltaic module in a direction away from the mounting target object; and a pair of claws deforming by an external force and formed at the vertical wall portions, tilted with respect to the vertical wall portions, and having a distance between tips smaller than a width of the base portion.

### CROSS-REFERENCE TO RELATED APPLICATION

This application is a Continuation application of PCT Application No. PCT/JP2022/044254, filed Nov. 30, 2022, the entire contents of which are incorporated herein by reference.

### FIELD

The present invention relates to a fastening tool and a fastening device for fastening photovoltaic modules to an installation position.

### BACKGROUND

Photovoltaic power generation systems for generating power with multiple photovoltaic modules fastened, for example, to a roof of a house have been known. As a technique for fastening the photovoltaic modules to the roof, Jpn. Pat. Appln. KOKAI Publication No. 2018-109322 discloses a technique of securing a base member between two photovoltaic modules adjacent to each other on the roof and fastening to this base member a pressing member for pressing edge portions of the two adjacent photovoltaic modules with bolts and nuts.

The fastening by the bolts and the nuts, however, has the following issues. That is, in order to confirm that the bolts and the nuts have not been forgotten to be fastened, for example, it is conceivable that a worker would manually check the looseness of the bolts and the nuts, but such manual checking work is inefficient.

### SUMMARY

According to one aspect of the embodiment, the fastening tool is a fastening tool to mount a plate-shaped photovoltaic module to a mounting target object, and it includes: a support member including a pair of vertical wall portions and a pair of mounting portions formed at upper ends of the pair of vertical wall portions and configured to mount the photovoltaic module thereon, the support member being arranged on the mounting target object; a pressing member including a base portion fastened to the mounting target object by a fastening member via the support member, and a regulating provided at the base portion and configured to regulate movement of the photovoltaic module in a direction away from the mounting target object, the pressing member being arranged between the pair of vertical wall portions; and a pair of claws configured to deform by an external force, the pair of claws being formed at the pair of vertical wall portions, being tilted with respect to the vertical wall portions, and having a distance between tips smaller than a width of the base portion. The pair of claws are configured to, prior to the fastening of the base portion to the mounting target object by the fastening member, abut on the base portion, and tilt the pressing member with respect to a posture of the regulating portion regulating movement of the photovoltaic module.

### BRIEF DESCRIPTION OF THE DRAWINGS

FIG. 1 is an exploded perspective view showing a photovoltaic power generation system using a fastening device according to a first embodiment of the present invention.

FIG. 2 is a cross-sectional view showing the photovoltaic power generation system.

FIG. 3 is a perspective view showing the fastening device.

FIG. 4 is a side view showing a configuration of the photovoltaic power generation system in a state before an eaves-side photovoltaic module is fastened.

FIG. 5 is a side view showing the configuration of the photovoltaic power generation system in a state where the eaves-side photovoltaic module is fastened.

FIG. 6 is a side view showing the configuration of the photovoltaic power generation system in a state where a ridge-side photovoltaic module is inserted.

FIG. 7 is a front view showing a configuration of a support member used in a fastening tool of the fastening device.

FIG. 8 is a plan view showing a structure of the support member.

FIG. 9 is a side view showing the structure of the support member.

FIG. 10 is a front view showing a dimensional structure of the support member and a pressing member of the fastening tool.

### DETAILED DESCRIPTION

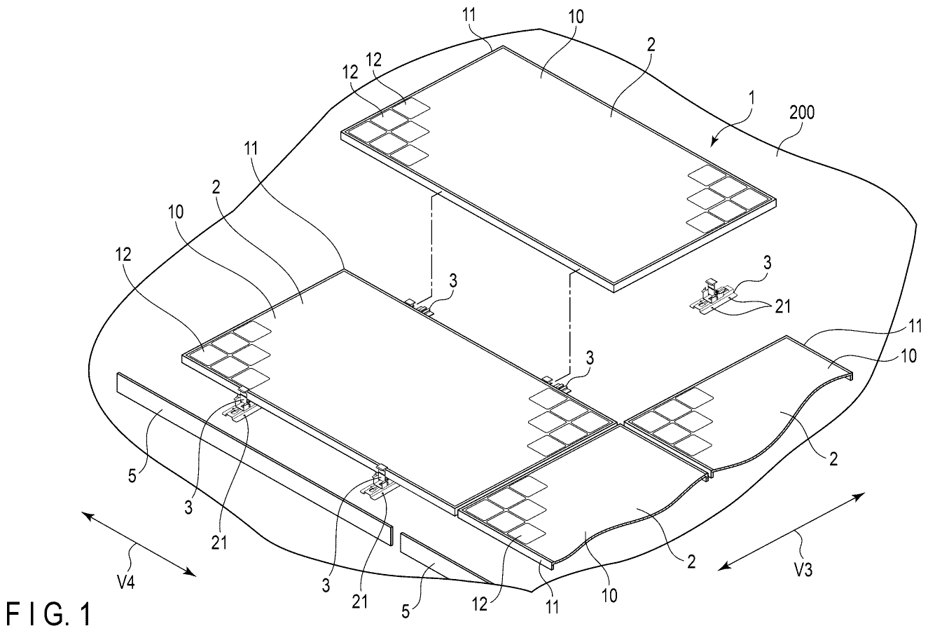

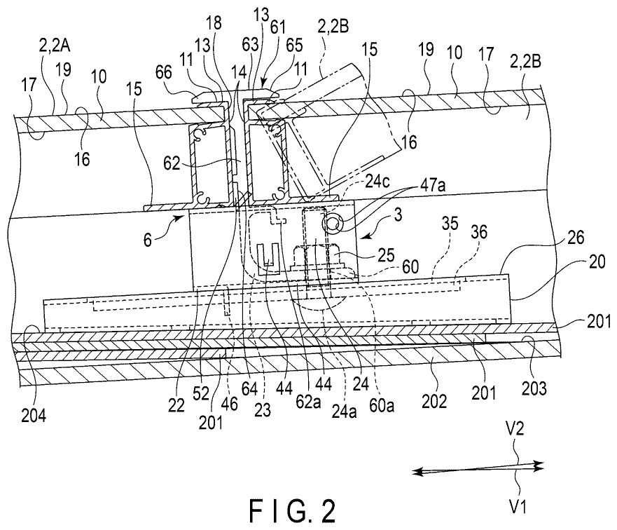

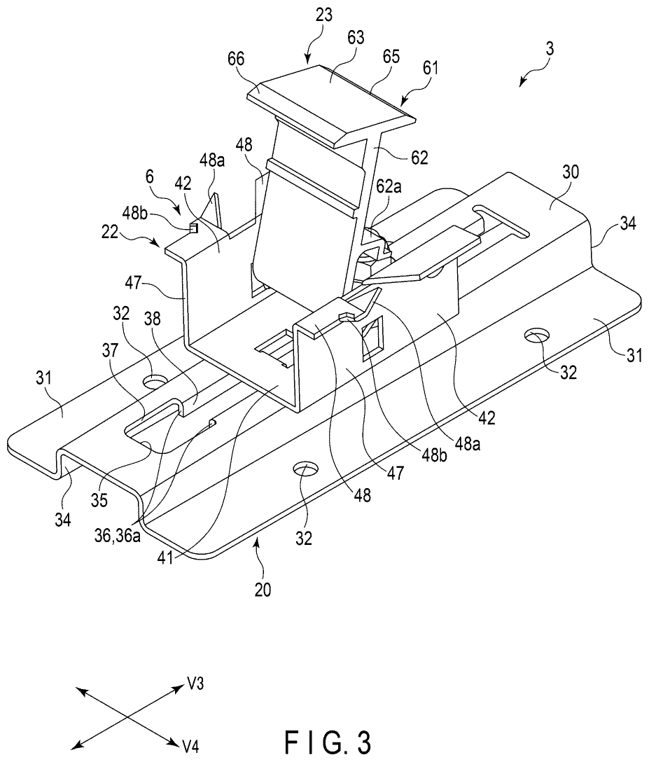

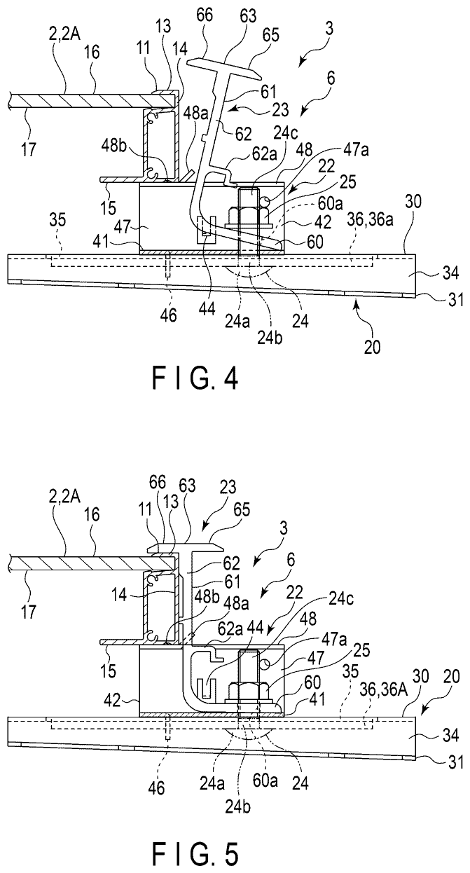

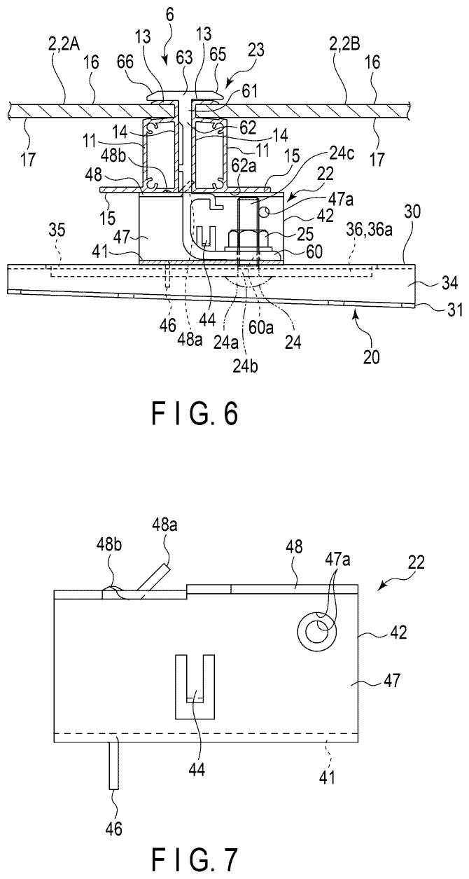

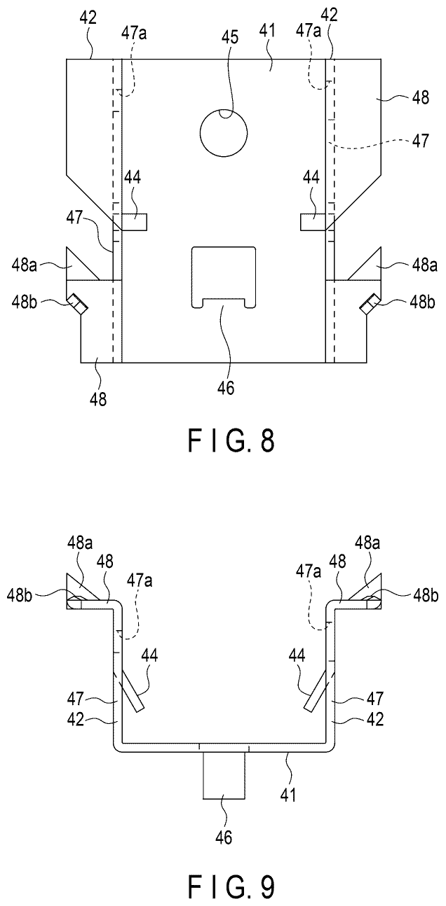

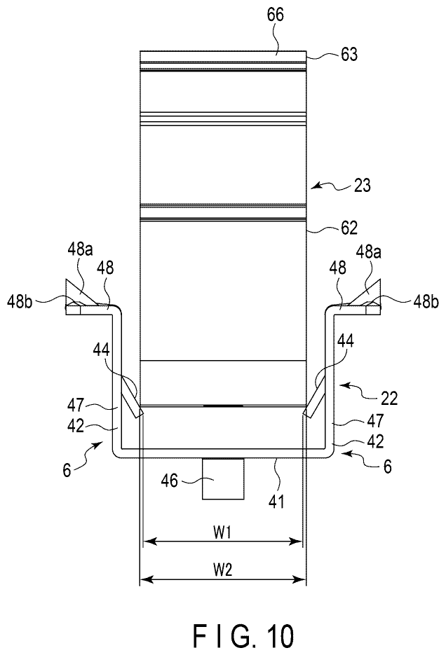

A fastening device 3 and a photovoltaic power generation system 1 using the fastening device 3 according to an embodiment of the present invention will be described with reference to FIGS. 1 to 10. FIG. 1 is an exploded perspective view showing the photovoltaic power generation system 1. FIG. 2 is a cross-sectional view showing the photovoltaic power generation system 1. FIG. 3 is a perspective view showing the fastening device 3. FIG. 4 is a side view showing a configuration of the photovoltaic power generation system 1 in a state before an eaves-side photovoltaic module 2 is fastened. FIG. 5 is a side view showing the configuration of the photovoltaic power generation system 1 in a state where the eaves-side photovoltaic module 2 is fastened. FIG. 6 is a side view showing the configuration of the photovoltaic power generation system 1 in a state where a ridge-side photovoltaic module 2 is inserted. FIG. 7 is a front view showing the configuration of a support member 22 used in a fastening tool 6 of the fastening device 3. FIG. 8 is a plan view showing a structure of the support member 22. FIG. 9 is a side view showing the structure of the support member 22. FIG. 10 is a front view showing a dimensional structure of the support member 22 and a pressing member 23 of the fastening tool 6. In FIGS. 2 and 4 to 6, the photovoltaic power generation system 1 or the fastening device 3 is shown in a posture in which the right side is the ridge side and the left side is the eaves side.

As illustrated in FIGS. 1 and 2, the photovoltaic power generation system 1 is installed on a roof 200 of a house which is an example of an installation position. As illustrated in FIG. 2, the roof 200 includes, for example, a plurality of roofing members 201. The roofing members 201 are, for example, slates. The roofing members 201 are arranged on an upper surface 203 of a roof board 202. The ridge-side end portion of the roofing member 201 is placed on the roof board 202, and the eaves-side end portion of the roofing member 201 is placed on another roofing member 201 on the eaves side of this roofing member 201. As shown in FIG. 2, a first direction V1, which is a direction of an upper surface 204 of the roofing member 201 tilted with respect to an up-down direction, intersects a second direction V2, which is a direction of the upper surface 203 of the roof board 202 tilted with respect to the up-down direction.

As shown in FIG. 1, the photovoltaic power generation system 1 includes the plurality of photovoltaic modules 2, the plurality of fastening devices 3, and a plurality of decorative plates 5. The photovoltaic power generation system 1 may be configured to use a plurality of eaves-side fastening devices different from the fastening device 3 as the fastening device for fastening the eaves side of the photovoltaic module 2 arranged closest to the eaves side of the plurality of arranged photovoltaic modules 2.

The plurality of photovoltaic modules 2 are attached to the roof 200 by the plurality of fastening devices 3 or by the plurality of fastening devices 3 and the plurality of eaves-side fastening devices. The plurality of photovoltaic modules 2 are arranged in both a third direction V3, which is parallel to a direction from the ridge toward the eaves, and a fourth direction V4, which is orthogonal to the third direction V3, for example. The number of the photovoltaic modules 2 is suitably determined in accordance with the size of the installation position, a targeted output, and the like.

The photovoltaic module 2 is configured in a plate shape. The photovoltaic module 2 includes, for example, a solar panel 10 and a frame 11. The solar panel 10 is configured by integrally attaching together a plurality of cells 12 that are constituted of solar cell elements and forming them into a plate. The solar panel 10 is configured in a rectangular plate shape, for example.

As shown in FIG. 2, the frame 11 is provided at an edge portion of the solar panel 10. In FIG. 2, the cross section of the photovoltaic module 2 is illustrated. The frame 11 includes a base part formed of a conductive metal material and a protective layer provided on a surface of the base part for corrosion prevention. The protective layer is formed by, for example, plating the base part.

The frame 11 includes, for example, an upper surface portion 13, a side surface portion 14, and a lower surface portion 15. The upper surface portion 13 is formed to surround an edge portion of an upper surface 16, an edge portion of a lower surface 17, and a side surface 18 of the solar panel 10. The side surface portion 14 extends downward from the upper surface portion 13. The lower surface portion 15 extends from the lower end of the side surface portion 14 toward the inside of the frame 11.

As shown in FIGS. 1 and 2, the fastening device 3 is provided, for example, between two photovoltaic modules 2 adjacent in the third direction V3. The fastening device 3 fastens the two adjacent photovoltaic modules 2 to the roof 200.

As shown in FIGS. 2 and 3, the fastening device 3 includes, for example, a base member 20, a fastening member 21 for fastening the base member 20 to the roof 200, a fastening tool 6, and a bolt 24 and a nut 25 that serve as a fastening member for fastening the fastening tool 6 to the base member 20.

The base member 20 is an example of a mounting target object on which the photovoltaic module 2 is mounted. The base member 20 is formed in a shape elongated in one direction, for example, the third direction V3, when fastened to the roof 200. The length of the base member 20 in the longitudinal direction is determined to be shorter than that of the photovoltaic module 2 in the third direction V3. The roof board 202 is an example of a base part of the roof 200 on which the roofing members 201 are provided.

The base member 20 includes, for example, a base portion 30, a pair of vertical wall portions 34, and a pair of flanges 31, as shown in FIGS. 2 and 3.

The upper surface of the base portion 30 is formed into a flat surface. The upper surface of the base portion 30 is formed, for example, into a plane that becomes parallel to the upper surface 203 of the roof board 202, which is an example of a base part, in a state where the base member 20 is fastened to the roof 200. The base portion 30 is formed into a plate shape elongated in one direction. The base portion 30 includes a groove 35 and a regulating portion 36.

The groove 35 pierces through the base portion 30 and extends along the longitudinal direction of the base portion 30. The groove 35 is provided, for example, in the center in the width direction of the base portion 30, extending from the vicinity of one end of the base portion 30 to the vicinity of the other end in the longitudinal direction. In the groove 35, a screw portion 24c of the bolt 24, which will be described later, can be arranged in a movable manner in the longitudinal direction of the groove 35.

The groove 35 includes a first portion 37 and a second portion 38. The first portion 37 forms, for example, one end portion of the groove 35. The length and width of the first portion 37 along the longitudinal direction of the groove 35 are set to dimensions that allow a head portion 24a, which will be described later, of the bolt 24 to pass through. The first portion 37 is provided at the eaves-side end portion of the groove 35 in a state where the base member 20 is fastened to the roof 200.

The second portion 38 forms the other end side of the groove 35 with respect to the first portion 37. The length and width of the second portion 38 along the longitudinal direction of the groove 35 are set to dimensions that allow the screw portion 24c to be arranged and that do not allow the head portion 24a to pass through. In the present embodiment, for example, the width of the second portion 38 is set to be sufficient for a base portion 24b, which will be described later, of the bolt 24 to move through. In the second portion 38 having the edges extending along the longitudinal direction with respect to the width direction, one of these edges is linearly continuous with the edge of the first portion 37.

The regulating portion 36 is configured to regulate the rotation of the bolt 24. The regulating portion 36 is provided on, for example, the lower surface of the base portion 30. The regulating portion 36 includes, for example, a pair of vertical wall portions 36a at the two edges of the second portion 38 along the longitudinal direction. The distance between the pair of vertical wall portions 36a is set to such a distance that the base portion 24b of the bolt 24 can be arranged in between and that the rotation of the bolt 24 can be regulated with the inner surfaces of the pair of vertical wall portions 36a abutting against the outer surface of the base portion 24b.

In another example, the regulating portion 36 may be configured by the inner surface of the groove 35. For instance, in the case where the thickness of the base portion 30 is sufficient to receive at least part of the base portion 24b in the groove 35 with the bolt 24 and the nut 25 engaged with each other, the rotation of the bolt 24 can be regulated with the inner surface of the groove 35 abutting on the base portion 24b.

The pair of vertical wall portions 34 are formed, for example, at the edges of the base portion 30 along the longitudinal direction. The length of the pair of vertical wall portions 34 in a vertical direction is set to a dimension such that the upper surface of the base portion 30 is a plane parallel to the upper surface 203 of the roof board 202 in a state where the base member 20 is fastened to the roof 200. In the example of the present embodiment, the vertical length of the vertical wall portion 34 is set to a dimension that gradually increases from one end on the eaves side, that is, one end on the first portion 37 side, toward the other end side.

The pair of flanges 31 are formed at the lower end edges of the outer surfaces of the pair of vertical wall portions 34. The pair of flanges 31 are formed in a rectangular plate shape, for example. One or more holes 32 are formed in each flange 31, through which a fastening member 21 is inserted. The hole 32 is formed, for example, on each of one end side and the other end side of the flanges 31 in the longitudinal direction.

The fastening member 21 is, for example, a screw. The fastening member 21 is inserted into the hole 32 and engaged to the roofing member 201 and the roof board 202, thus fastening the base member 20 to the roofing member 201 and the roof board 202.

The fastening tool 6 includes a support member 22 mounted on the base member 20, and a pressing member 23 to press the upper surface portion 13 of the frame 11, which is an example of the upper surface 16 of the photovoltaic module 2.

The support member 22 is mounted on the upper surface of the base portion 30, as shown in FIGS. 2 to 6. The support member 22 includes a support portion that supports a part of the lower surface of the photovoltaic module 2, which is an example of the main surface of the photovoltaic module 2 on the base member 20 side, for example, a part of the edge portion. That is, as shown in FIGS. 2 and 4 to 6, the support member 22 carries the photovoltaic module 2 and is arranged on the base member 20. As shown in FIGS. 2 to 9, the support member 22 includes, for example, a support member base portion 41, a pair of support portions 42, and a pair of claws 44. The support member 22 is formed of a conductive material. The support member 22 is formed of, for example, aluminum, iron, or a resin. Preferably, the support member 22 is made of a material that can be subjected to press working, and, for example, is preferably formed of a steel material containing iron as a main material.

The support member base portion 41 is mounted on the upper surface of the base portion 30. The support member base portion 41 is formed into a rectangular plate shape, for example. As a specific example, the support member base portion 41 is formed into a rectangular plate shape which is short in the width direction of the base member 20, that is, long in the longitudinal direction of the base member 20. The length (width) of the support member base portion 41 in the lateral direction is greater than the width of the base portion 30. The support member base portion 41 has a hole 45 in which the threaded portion 24c of the bolt 24 is arranged. The support member base portion 41 has a guided portion 46 that is arranged in the groove 35 of the base member 20 and guides the support member 22 to move along the groove 35.

The guided portion 46 is set to have a width smaller than the width of the groove 35 in a direction orthogonal to the longitudinal direction of the groove 35, for example, and is formed to be movable in the groove 35 along the longitudinal direction of the groove 35. The guided portion 46 is formed by, for example, bending a part of the support member base portion 41 toward the groove 35 side which is the lower side.

The support portion 42 supports two photovoltaic modules 2 on the upper surface. More specifically, the support portion 42 supports a part of the edge portion of the lower surface of each of the two adjacent photovoltaic modules 2 aligned in the third direction V3. The pair of support portions 42 are formed at both ends of the support member base portion 41 in the lateral direction (the fourth direction V4). The support portion 42 includes, for example, a vertical wall portion 47 and a mounting portion 48.

The vertical wall portion 47 is formed into a plate shape standing upright from the support member base portion 41. The mounting portion 48 is provided on an upper end of the vertical wall portion 47. A hole 47a is formed in the vertical wall portion 47. For example, a ground wire is fixed in the hole 47a formed in one of the pair of vertical wall portions 47, and for example, wiring of the photovoltaic module 2 is fixed in the hole 47a formed in the other of the pair of vertical wall portions 47. Therefore, for example, as shown in FIGS. 7 to 9, the hole 47a in which the ground wire is fixed is formed to have a smaller diameter than the hole 47a in which the wiring is fixed. Further, for example, the hole 47a is arranged on the ridge-side of the vertical wall portion 47. The number, shape, size, and the like of the holes 47a can be appropriately changed depending on various wires to be fixed and the intended use.

A part of the edge portion of the lower surface of the photovoltaic module 2 is mounted on the mounting portion 48. The mounting portion 48 is formed into a rectangular plate shape that extends in a direction opposite to the direction in which the pair of vertical wall portions 47 face each other (the fourth direction V4) and is partially cut out, for example. The mounting portion 48 is cut out in the center side in the longitudinal direction (direction orthogonal to the facing direction of the pair of vertical wall portions 47, third direction V3) of the support member base portion 41, and has a first protrusion 48a provided at the cut-out portion and a second protrusion 48b provided closer to the eaves side than the first protrusion 48a in the third direction V3.

The first protrusion 48a is formed to have, for example, a sharp tip so that the protection layer on the surface of the side surface portion 14 of the frame 11 of the ridge-side photovoltaic module 2 (one photovoltaic module) can be damaged by the tip. As a specific example, in the first protrusion 48a, for example, a part of the mounting portion 48 is formed in a triangular shape, for example, in a two right-angled triangle or an isosceles sided shape of a triangle. The first protrusion 48a is tilted with respect to each of the upper surface of the mounting portion 48 and a direction intersecting a direction orthogonal to the upper surface of the mounting portion 48, and extends toward the ridge-side. The first protrusion 48a is formed by, for example, cutting out the central portion of the mounting portion 48 into two sides of a triangle and bending the central portion by press working. In the case where the photovoltaic module 2 supported on the ridge-side of the support member 22 is mounted on the mounting portion 48, the first protrusion 48a breaks through the protection layer on the eaves-side side surface of the frame 11 and abuts on the base part of the frame 11.

The base end portion of the first protrusion 48a continuous with the mounting portion 48 is provided at a portion where the photovoltaic module 2 is mounted on the eaves side of the mounting portion 48 or a portion facing the first regulating portion 62 of the pressing member 23. The tip of the first protrusion 48a is arranged above the upper surface of the mounting portion 48, and up to a position where the side surface portion 14 of the frame 11 of the ridge-side photovoltaic module 2 of the mounting portion 48 is arranged or up to a position slightly closer to the ridge side than the position where the side surface portion 14 of the frame 11 of the ridge-side photovoltaic module 2 is arranged.

The second protrusion 48b is formed to have, for example, a sharp tip so that the protection layer on the surface of the lower surface portion 15 of the frame 11 of the eaves-side photovoltaic module 2 (the other photovoltaic module) can be damaged by the tip. As a specific example, the second protrusion 48b is formed by, for example, a part of the mounting portion 48 being formed in a triangular shape, for example, in a two sided shape of a right-angled triangle or an isosceles triangle. The second protrusion 48b is, for example, orthogonal to the upper surface of the mounting portion 48 and projects upward. The second protrusion 48b is formed by, for example, cutting out a part of the mounting portion 48 into two sides of a triangle and bending the cutout by press working. In the case where the photovoltaic module 2 supported on the eaves side of the support member 22 is mounted on the mounting portion 48, the second protrusion 48b breaks through the protection layer on the surface of the lower surface of the frame 11 and abuts on the base part of the frame 11.

The pair of claws 44 are provided on the pair of support portions 42. The pair of claws 44 are provided to face each other in the width direction of the support member 22 (the facing direction of the pair of vertical wall portions 47, the fourth direction V4). The claw 44 is integrally provided on the support portion 42, and a tip thereof is arranged closer to the center of the support member 22 than the inner surface of the vertical wall portion 47. The distance of the gap in the direction in which the pair of claws 44 face each other (the width direction of the support member 22, the fourth direction V4) gradually decreases from the upper side (the mounting portion 48) toward the lower side (the support member base portion 41). That is, the claw 44 is tilted at a predetermined angle with respect to the inner surface of the vertical wall portion 47 so as to be tilted from the upper side to the lower side. In other words, the distance between the pair of claws 44 in the facing direction is the same as the distance between the pair of vertical wall portions 47 at the upper end of the claw 44, and is smaller than the distance between the pair of vertical wall portions 47 at the lower end of the claw 44.

As shown in FIG. 10, the distance W1 between the lower ends of the pair of claws 44 is smaller than the width W2 of the base portion 60, which will be described later, of the pressing member 23 in the fourth direction V4, so that the pressing member 23 can be regulated from moving downward beyond the claws 44. The pair of claws 44 are formed to be elastically deformable by an external force.

For example, the upper end of the claw 44 is continuous with the vertical wall portion 47. As a specific example, the claw 44 is formed integrally with the vertical wall portion 47 by punching out a part of the vertical wall portion 47 shown in FIG. 9 into a rectangular shape except for one side, or a U-shape, a V-shape, or the like, so that the upper end is continuous with the vertical wall portion 47, and plastically deforming the punched out part by bending so as to form a predetermined angle smaller than 90° with respect to the vertical wall portion 47. With these pair of claws 44, by the pair of claws 44 abutting on the base portion 60, which will be described later, of the pressing member 23, the pressing member 23 is provided at a position tilted with respect to the support member base portion 41. As a specific example, the pair of claws 44 are provided to the center side in the longitudinal direction (third direction V3) of the vertical wall portions 47.

As shown in FIGS. 2 to 6, the pressing member 23 is mounted on the support member base portion 41 of the support member 22. The pressing member 23 is configured to be able to regulate movement of the photovoltaic module 2. The pressing member 23 includes, for example, the base portion 60 and a regulating portion 61. The pressing member 23 is formed of, for example, iron, aluminum, or stainless steel.

The base portion 60 configures, for example, the lower end of the pressing member 23, and is arranged on the pair of claws 44 when arranged in the support member 22, and is moved onto the support member base portion 41 against the pair of claws 44 by being engaged by the bolt 24 and the nut 25, and is thus arranged on the support member base portion 41. The base portion 60 is formed in a rectangular plate shape that is long in a direction (longitudinal direction, third direction V3) orthogonal to the width direction of the base member 20, for example. The base portion 60 has a width W2 (length in the lateral direction of the base portion 60) that is smaller than the distance between the upper ends of the pair of claws 44 in the facing direction and greater than the distance W1 between the lower ends of the pair of claws 44 in the facing direction. The base portion 60 has a hole 60a formed in a shape that allows the screw portion 24c of the bolt 24 to be inserted therethrough but does not allow the head portion 24a of the bolt 24 and the nut 25 to be inserted therethrough. In a specific example, the hole 60a is formed as a round hole having a radius greater than that of the screw portion 24c and smaller than the minimum width of the head portion 24a. The hole 60a has a dimension that allows the pressing member 23 to be moved between a first state P1 and a second state P2, which will be described later, with the screw portion 24c arranged.

The regulating portion 61 is provided in the base portion 60 and is configured to be able to regulate movement of the photovoltaic module 2. The regulating portion 61 includes, for example, a first regulating portion 62 and a second regulating portion 63.

The first regulating portion 62 is formed in a shape that stands upward from one end portion of the base portion 60, in other words, the eaves side of the base portion 60, specifically, the edge on the eaves side of the upper surface of the base portion 60. For example, the first regulating portion 62 extends from the base portion 60 in a direction of 90° with respect to the base portion 60. The first regulating portion 62 is formed in a rectangular plate shape, for example. The ridge-side surface of the first regulating portion 62 abuts against the eaves-side side surface portion 14 of the ridge-side photovoltaic module 2, thereby regulating the movement of the photovoltaic module 2 toward the eaves side. A ridge-side surface of the first regulating portion 62 is provided with a regulating protrusion 62a that faces a part of an edge portion of the lower surface of the ridge-side photovoltaic module 2.

The regulating protrusion 62a is formed in a stepped shape having an upper surface at a different height position or a flat plate shape, for example. In the present embodiment, the regulating protrusion 62a is formed in a stepped shape descending toward the base portion 60 side in a direction away from the first regulating portion 62. The regulating protrusion 62a is at least partially positioned above the upper surface of the mounting portion 48 of the support member 22 in the second state P2 where the pressing member 23 is tilted by the pair of claws 44, and when the ridge-side photovoltaic module 2 is inserted, regulates the movement of the photovoltaic module 2. In the first state P1 in which the pressing member 23 passes over the pair of claws 44 and the base portion 60 abuts on the support member base portion 41, the regulating protrusion 62a is positioned below the upper surface of the mounting portion 48 of the support member 22 and is formed so that the ridge-side photovoltaic module 2 can be inserted.

The eaves-side surface of the first regulating portion 62 abuts on the ridge-side side surface portion 14 of the eaves-side photovoltaic module 2, thereby regulating the movement of the photovoltaic module 2 toward the ridge side.

The first regulating portion 62 may abut on the side surface portion 14 of the photovoltaic module 2 with the photovoltaic module 2 attached to the base member 20. Alternatively, the first regulating portion 62 may have a gap between the first regulating portion 62 and the side surface portion 14, and if the photovoltaic module 2 moves toward the eaves side or the ridge side by a predetermined distance, the first regulating portion 62 may abut on the side surface portion 14, thereby regulating the movement of the photovoltaic module 2.

The second regulating portion 63 is formed, for example, on the upper end of the first regulating portion 62. The second regulating portion 63 comes into contact with the upper surface portion 13 of the frame 11, which is an exemplary main surface of the photovoltaic module 2 opposite to the base member 20, thereby regulating the movement of the photovoltaic module 2 in a direction away from the base member 20. The second regulating portion 63 includes, for example, a third regulating portion 65 and a fourth regulating portion 66.

The third regulating portion 65 is formed into a plate extending from the first regulating portion 62 to the ridge side. The third regulating portion 65 faces the base portion 60 and the regulating protrusion 62a in the longitudinal direction of the first regulating portion 62. As indicated by the double-dashed chain line in FIG. 2, the distance between the third regulating portion 65 and the regulating protrusion 62a is set to be greater than the dimension (thickness) along the vertical direction of the frame 11 of the photovoltaic module 2, such that the photovoltaic module 2 held in an oblique posture can be inserted between the third regulating portion 65 and the regulating protrusion 62a when the pressing member 23 is in a first posture P1. As indicated by the double-dashed chain line in FIG. 2, the distance between the third regulating portion 65 and the regulating protrusion 62a is set to be greater than the thickness of the frame 11 such that the photovoltaic module 2 held in the oblique posture cannot be inserted between the third regulating portion 65 and the regulating protrusion 62a when the pressing member 23 is in the second posture P2 as shown in FIG. 4.

Here, as indicated by the double-dashed chain line in FIG. 2, the oblique posture of the photovoltaic module 2 indicates a posture in which the longitudinal direction (main surface direction) of the photovoltaic module 2 is tilted with respect to the extending direction of the third regulating portion 65 and the regulating protrusion 62a, and the ridge-side end of the photovoltaic module 2 is arranged above the eaves-side end.

The third regulating portion 65 is separated from the upper surface of the photovoltaic module 2 (frame 11) with a gap therebetween in a state where the photovoltaic module 2 is attached to the fastening tool 6, and regulates the movement of the photovoltaic module 2 by abutting on the photovoltaic module 2 when the photovoltaic module 2 is moved upward by a predetermined distance. The third regulating portion 65 may be configured to abut on the upper surface portion 13 of the photovoltaic module 2.

The fourth regulating portion 66 is formed into a plate extending to the eaves side. The fourth regulating portion 66 faces the support member base portion 41 of the support member 22 when the regulating portion 61 is in the first state P1. The distance between the fourth regulating portion 66 and the mounting portion 48 when the regulating portion 61 is in the first state P1 is set to be equal to the thickness of the edge portion of the photovoltaic module 2. The fourth regulating portion 66 abuts on the upper surface portion 13 of the photovoltaic module 2 in a state where the photovoltaic module 2 is attached to the fastening tool 6, and presses the photovoltaic module 2, thereby fastening the photovoltaic module 2.

In the case where the bolt 24 and the nut 25 inserted through the groove 35 of the base member 20, the hole 45 of the support member 22, and the hole 60a of the base portion 60 are engaged, the pressing member 23 configured as described above presses the pair of claws 44 by the base portion 60 and deforms the pair of claws 44, and is in the first state P1 in which the base portion 60 abuts on the upper surface of the support member base portion 41. Here, the first state P1 is a state in which the regulating portion 61 can regulate the movement of the photovoltaic module 2. In the present embodiment, the first state P1 is a posture of the pressing member 23 in which the first regulating portion 62 can abut on the side surface portion 14 of the frame 11 of the photovoltaic module 2 and the fourth regulating portion 66 of the second regulating portion 63 abuts on the upper surface portion 13 of the frame 11 of the photovoltaic module 2 on the eaves side.

In a temporarily fixed state of the pressing member 23 and before the first state P1, the pressing member 23 is in the second state P2 in which the base portion 60 is arranged on the pair of claws 44 and the first regulating portion 62 is tilted with respect to the upper surface of the support member base portion 41. Here, the temporarily fixed state means that the pressing member 23 is arranged on the support member 22, and the nut 25 and the bolt 24 are partially screwed, but the nut 25 and the bolt 24 are not completely engaged. In the second state P2, the pressing member 23 is in a posture tilted toward the ridge-side with respect to the first state P1. In the second state P2, the pressing member 23 has a greater gap between the fourth regulating portion 66 and the upper surface portion 13 of the photovoltaic module 2 than in the first state P1.

When the pressing member 23 moves from the second state P2 to the first state P1, the pair of claws 44 having the distance W1 smaller than the width W of the base portion 60 are pressed by the base portion 60 and elastically deformed, and the distance W1 between the pair of claws 44 becomes greater than the width W2 of the base portion 60. When the base portion 60 passes over the pair of elastically deformed claws 44, the pair of claws 44 are restored, and the distance W1 between the pair of claws 44 becomes smaller than the width W2 of the base portion 60. Thus, in the case where the pressing member 23 moves from the second state P2 to the first state P1, and then moves from the first state P1 to the second state P2, the base portion 60 abuts on the pair of claws 44 that have been restored, and thus the movement of the pressing member 23 to the second state P2 is regulated.

The bolt 24 and the nut 25 are an example of a fastening member that fastens the support member 22 and the pressing member 23 to the base member 20. The bolt 24 has, for example, a head portion 24a and the screw portion 24c in which a female screw is formed. The bolt 24 and the nut 25 are engaged with the base member 20, the support member 22, and the pressing member 23 interposed, thereby fastening the support member 22 and the pressing member 23 to the base member 20. The bolt 24 and the nut 25 are engaged to press the pressing member 23 downward and elastically deform the pair of claws 44, thereby moving the pressing member 23 from the second state P2 to the first state P1 against the pair of claws 44.

The bolt 24 has an abutting portion which abuts on the regulating portion 36 to regulate the rotation of the bolt 24. The abutting portion is provided, for example, between the head portion 24a and the threaded portion 24c of the bolt 24. The bolt 24 is, for example, a square-root round-head bolt, and has a head portion 24a, a base portion 24b as an example of an abutting portion, and the screw portion 24c. The base portion 24b is formed in a polygonal shape, for example, a rectangular shape, or has a pair of flat surfaces formed at symmetrical positions which abut on the pair of regulating portions 36. The diameter of the circumscribed surface of the base portion 24b is greater than the width of the groove 35, and the width of two surfaces that are paired (at symmetrical positions) among the plurality of flat surfaces formed on the base portion 24b is smaller than the width of the groove 35.

With the bolt 24, in a posture in which the head portion 24a is arranged below the base portion 30 of the base member 20, for example, the screw portion 24c is inserted through the groove 35 of the base member 20, the hole 45 of the support member 22, and the hole 60a of the pressing member 23. The nut 25 is screwed into, for example, a portion of the screw portion 24c above the base portion 60. The nut 25 is engaged with the bolt 24 with the support member base portion 41 of the support member 22 and the base portion 60 of the pressing member 23 interposed.

The decorative plate 5 covers the fastening tool 6 positioned closest to the eaves side. In the case where the photovoltaic power generation system 1 includes an eaves-side fastening device, in addition to the fastening device 3, the decorative plate 5 covers the eaves-side fastening device. Here, the eaves-side fastening device fastens, for example, the photovoltaic module 2 arranged closest to the eaves side. The eaves-side fastening device is an example of a fastening device that fastens the photovoltaic module 2. The eaves-side fastening device may be the fastening tool 6. Next, the operation of fastening the photovoltaic module 2 to the roof 200 using the fastening device 3 will be described. In the following description, the photovoltaic module 2 arranged on the eaves side of the fastening device 3 (the pressing member 23) will be referred to as a first photovoltaic module 2A, and the photovoltaic module 2 arranged on the ridge side of the fastening device 3 will be referred to as a second photovoltaic module 2B.

First, the worker arranges the plurality of eaves-side fastening devices and the plurality of fastening devices 3 to the fastening positions on the roof 200. At this time, the pressing member 23 of the fastening device 3 is in the second state P2 as shown in FIG. 4. The worker arranges the eaves-side end portion of the first photovoltaic module 2A on the eaves-side fastening device 3 or the eaves-side fastening device, and places the ridge-side end portion of the first photovoltaic module 2A on the mounting portion 48 of the support member 22 of the fastening device 3 on which the eaves-side end portion of the first photovoltaic module 2A is arranged or the fastening device 3 closer to the ridge side than the eaves-side fastening device.

At this time, the worker moves the support member 22 and the pressing member 23 of the fastening device 3, on which the ridge-side end portion of the first photovoltaic module 2A is placed, along the groove 35. By this operation, the worker adjusts the positions of the support member 22 and the pressing member 23 to suitable positions with respect to the photovoltaic module 2A, for example, to positions at which the frame 11 and the first regulating portion 62 abut on each other. In the case where the first photovoltaic module 2A is mounted on the mounting portion 48, the second protrusion 48b breaks the protection layer of the frame 11 so as to abut on the base part of the frame 11. Thus, the base part of the frame 11 and the support member 22 are electrically connected to each other.

Next, the worker engages the bolt 24 and the nut 25 inserted into the groove 35 of the base member 20, the hole 45 of the support member 22, and the hole 60a of the base portion 60, and fastens the support member 22 and the pressing member 23 to the base member 20. By engaging the bolt 24 and the nut 25, the base portion 60 of the pressing member 23 presses the pair of claws 44. When the pair of claws 44 pressed by the base portion 60 are elastically deformed, the base portion 60 rides on the pair of claws 44. As a result, as illustrated in FIG. 5, the pressing member 23 moves from the second state P2 to the first state P1. The pressing member 23 in the first state P1 sandwiches the eaves-side photovoltaic module 2A between the pressing member 23 and the support member 22, and fastens the first photovoltaic module 2A.

Next, the worker visually recognizes the plurality of fastening devices 3 for fastening the first photovoltaic module 2A, and checks that the bolts 24 and the nuts 25 are engaged. In the case where it is in the temporarily fixed state where the bolt 24 and the nut 25 are not fastened, as shown in FIG. 4, because the pressing member 23 is in the second state P2, the first regulating portion 62 and the second regulating portion 63 are tilted with respect to the upper surface of the mounting portion 48 of the support member 22 (the upper surface of the photovoltaic module 2), and thus the worker can easily visually recognize the temporarily fixed state.

Next, as shown by the double-dashed chain line in FIG. 2, the worker inserts the second photovoltaic module 2B between the third regulating portion 65 and the mounting portion 48 in a posture in which the upper surface of the second photovoltaic module 2B is tilted with respect to the upper surface of the mounting portion 48. At this time, the first protrusion 48a breaks the protection layer of the side surface portion 14 of the frame 11 of the second photovoltaic module 2B to abut on the base part, and thus the base part of the frame 11 of the second photovoltaic module 2B and the support member 22 become electrically conductive. Thus, the first photovoltaic module 2A and the second photovoltaic module 2B become electrically conductive via the support member 22. Next, the worker lowers the ridge-side end portion of the second photovoltaic module 2B and places the ridge-side end portion of the second photovoltaic module 2B on the mounting portion 48 of the support member 22 facing the ridge-side end portion of the second photovoltaic module 2B.

Next, in the same manner as the above fastening operation of the ridge-side end portion of the first photovoltaic module 2A by the fastening device 3, the worker fastens the ridge-side end portion of the second photovoltaic module 2B by the fastening device 3. The worker repeats the above steps to perform the fastening operation of the first photovoltaic module 2A and the second photovoltaic module 2B using the fastening device 3, and sequentially fastens the photovoltaic modules 2 to the roof 200 from the eaves side toward the ridge side.

The plurality of photovoltaic modules 2 aligned in one row in the third direction V3 become electrically conductive via the support members 22 of the plurality of fastening devices 3 and the plurality of frames 11. The worker attaches the ground wire to the support member 22 of the fastening device 3 closest to the ridge side, for example, and grounds all the plurality of photovoltaic modules 2 aligned in a row from the eaves side to the ridge side, which are electrically conductive by the support members 22 of the plurality of fastening devices 3. The ground wire is electrically connected and fastened to, for example, a hole 47a for fixing the ground wire formed in one vertical wall portion 47 of the support member 22. In this manner, the fastening operation of the plurality of photovoltaic modules 2 to the roof 200 using the plurality of fastening devices 3 is completed.

In the fastening device 3 configured as described above, the pressing member 23 is in the second state P2, if the bolt 24 and the nut 25 are not engaged in the temporarily fixed state, with the pressing member 23 tilted by the pair of claws 44. Therefore, the worker can visually check that the pressing member 23 is in the second state P2, and thus can recognize that the bolt 24 and the nut 25 are not engaged. This can improve efficiency of the checking work, by the worker being able to easily check that the bolt 24 and the nut 25 are not left unengaged, that is, whether the fastening tool 6 is left unfastened. In particular, since a plurality of the fastening devices 3 are used for fastening one photovoltaic module 2, it takes time to check whether the photovoltaic module 2 has been forgotten to be fastened when the number of the photovoltaic modules 2 to be installed increases. However, the fastening devices 3 can reduce the time required for the checking work.

Further, the pair of claws 44 has a restoring force. The distance W1 between the pair of claws 44 is smaller than the width W of the base portion 60. Therefore, the pair of claws 44 can regulate the pressing member 23 from moving to the second state P2 after the pressing member 23 is in the first state P1, and thus the pressing member 23 can be prevented from coming off the support member 22 when the nut 25 is loosened or when replacing the bolt 24 and the nut 25.

Further, since the pair of claws 44 can be formed together when the support member 22 is formed by press working, the support member 22 can be manufactured easily and inexpensively.

Further, the fastening device 3 fastens the support member 22 to the base member 20 together with the pressing member 23 by using the bolt 24 and the nut 25. Therefore, the support member 22 and the pressing member 23 can be prevented from being displaced, and thus the efficiency of the fastening operation of the photovoltaic module 2 can be improved.

Furthermore, in the fastening device 3, the base member 20 is provided between the two photovoltaic modules 2, and the first regulating portion 62 abuts on the side surface portions 14 of the photovoltaic modules 2 on the ridge side and the eaves side, thereby regulating the movement of the photovoltaic modules 2 in the third direction V3. In the fastening device 3, the base member 20 is provided between two photovoltaic modules 2, and the second regulating portion 63 abuts on the upper surface portions 13 of the photovoltaic modules 2 on the ridge side and the eaves side or are separated from the upper surface portions 13 with a gap therebetween, and thus upward movement of the photovoltaic modules 2 is regulated. Therefore, the movement of the two photovoltaic modules 2 can be regulated by one fastening device 3.

An upper surface of the base portion 30 of the base member 20 is formed into a flat surface parallel to the roof board 202 in a state where the base member 20 is fastened to the roofing member 201. Therefore, the photovoltaic module 2 can be fastened in parallel with the roof board 202.

Furthermore, the base member 20 can move the support member 22 and the pressing member 23 in the temporarily fixed state along the groove 35, and thus the positions of the support member 22 and the pressing member 23 can be adjusted during the fastening operation of the photovoltaic module 2. Without the need to remove the base member 20 during the adjustment of the positions of the support member 22 and the pressing member 23, the efficiency in the operation of fastening the photovoltaic modules 2 can be improved.

Moreover, the base member 20 is configured such that the upper surface of the base portion 30 becomes parallel to the roof board 202 owing to the length of the vertical wall portion 34 in the vertical direction. This simplifies the configuration of the base member 20.

The groove 35 includes the first portion 37 through which the head portion 24a can be inserted. Therefore, the bolt 24 can be replaced without detaching the base member 20 from the roof 200. The base member 20 further includes a regulating portion 36 that regulates rotation of the bolt 24. Therefore, the efficiency in fastening of the bolt 24 and the nut 25 can be improved. Furthermore, the regulating portion 36 includes a pair of vertical wall portions 36a formed at a pair of edges of the groove 35. Therefore, the configuration of the regulating portion 36 can be simplified.

In the support member 22, a first protrusion 48a to become electrically conductive to a base part of the frame 11 of the ridge-side photovoltaic module 2 and a second protrusion 48b to become electrically conductive to the base part of the frame 11 of the eaves-side photovoltaic module 2 are formed on the mounting portion 48 for mounting the eaves-side and ridge-side photovoltaic modules 2. Thus, the conduction between each photovoltaic module 2 and the support member 22 can be achieved by simply arranging each photovoltaic module 2 on the support member 22, and the fastening device 3 can easily perform the conduction setting operation.

The first protrusion 48a and the second protrusion 48b formed on the support member 22 can be formed by bending a part of the mounting portion 48 when the support member 22 is subjected to press working. Therefore, the support member 22 can be manufactured easily and inexpensively.

Further, since the first protrusion 48a is electrically conductive to the base part of the side surface portion 14 of the frame 11 of the ridge-side photovoltaic module 2, when the photovoltaic module 2 is inserted between the support member 22 and the pressing member 23, the first protrusion 48a can be prevented from obstructing the insertion of the photovoltaic module 2.

The pressing member 23 has a regulating protrusion 62a in the first regulating portion 62, which prevents the photovoltaic module 2 in the oblique posture from being inserted in the second posture P2. Thus, the fastening device 3 can prevent the photovoltaic module 2 from being erroneously disposed between the support member 22 and the pressing member 23 in a state where the bolt 24 and the nut 25 are not engaged.

As described above, according to the fastening device 3 having the fastening tool 6 according to the embodiment, it is possible to easily check that the fastening tool 6 has been forgotten to be fastened.

The present invention is not limited to the foregoing embodiment. In the above-described example, the pair of claws 44 are integrally formed with the pair of vertical wall portions 47 of the support member 22 by bending or the like, but it is not limited thereto. For example, the pair of claws 44 may be formed separately from the pair of vertical wall portions 47 and fastened to the vertical wall portions 47 by welding, fastening with a fastening member such as a screw or a rivet, bonding with an adhesive, etc., or the like after the support member 22 is molded. In addition, an example in which the pair of claws 44 are elastically deformed when pressed by the pressing member 23, and are restored after the pressing member 23 passes over the pair of claws 44 has been described, but it is not limited thereto. For example, in the case where the pair of claws 44 are pressed by the pressing member 23, the pair of claws 44 may be configured to plastically deform or be damaged and not be restored.

That is, the present invention is not limited to the above-described embodiments, and various modifications can be made without departing from the scope of the present invention in the implementation stage. The embodiments may be appropriately implemented in combination, and in this case, combined effects can be obtained. Further, the above-described embodiments include various inventions, and various inventions can be extracted by combinations selected from a plurality of disclosed constituent features. For example, even if some of the constituent features are deleted from all the constituent features described in the embodiments, the configuration from which the constituent features are deleted can be extracted as an invention as long as the problem can be solved and the effects can be obtained.

What is claimed is:

1. A fastening tool to mount a plate-shaped photovoltaic module to a mounting target object, comprising:
a support member including a pair of vertical wall portions and a pair of mounting portions formed at upper ends of the pair of vertical wall portions and configured to mount the photovoltaic module thereon, the support member being arranged on the mounting target object;
a pressing member including a base portion fastened to the mounting target object by a fastening member via the support member, and a regulating portion provided at the base portion and configured to regulate movement of the photovoltaic module in a direction away from the mounting target object, the pressing member being arranged between the pair of vertical wall portions; and
a pair of claws configured to deform by an external force, the pair of claws being formed at the pair of vertical wall portions, being tilted with respect to the vertical wall portions, and having a distance between tips smaller than a width of the base portion,
wherein the pair of claws are configured to, prior to the fastening of the base portion to the mounting target object by the fastening member, abut on the base portion, and tilt the pressing member with respect to a posture of the regulating portion regulating movement of the photovoltaic module.

2. The fastening tool according to claim 1, wherein
the claws are configured to elastically deform by the external force.

3. The fastening tool according to claim 1, wherein
the regulating portion includes a first regulating portion and a second regulating portion, the first regulating portion being provided at the base portion, standing upward from the base portion, and facing a side surface of the photovoltaic module, the second regulating portion being provided at the first regulating portion and facing a main surface of the photovoltaic module on a side opposite to the mounting target object.

4. The fastening tool according to claim 3, wherein
the first regulating portion is arranged between two adjacent photovoltaic modules, and
the second regulating portion includes a third regulating portion facing one of the two photovoltaic modules and a fourth regulating portion facing another of the two photovoltaic modules.

5. The fastening tool according to claim 4, wherein
the fastening tool includes a first protrusion formed at the mounting portion and electrically conductive to a side surface portion of one photovoltaic module of the two photovoltaic modules, and a second protrusion electrically conductive to a lower surface portion of the other photovoltaic module of the two photovoltaic modules.

6. The fastening tool according to claim 5, wherein
the first protrusion and the second protrusion are formed by a part of the mounting portion.

7. A fastening tool to mount two plate-shaped adjacent photovoltaic modules to a mounting target object, comprising:
a support member including a pair of vertical wall portions and a pair of mounting portions formed at upper ends of the pair of vertical wall portions and configured to mount the photovoltaic module thereon, the support member being arranged on the mounting target object;
a pressing member including a base portion fastened to the mounting target object by a fastening member via the support member, and a regulating portion provided at the base portion and configured to regulate movement of the photovoltaic module in a direction away from the mounting target object, the pressing member being arranged between the pair of vertical wall portions;
a first protrusion formed at the mounting portion and electrically conductive to a side surface portion of one photovoltaic module of the two photovoltaic modules; and
a second protrusion formed at the mounting portion and electrically conductive to a lower surface portion of the other photovoltaic module of the two photovoltaic modules.

8. The fastening tool according to claim 7, wherein
the first protrusion and the second protrusion are formed by a part of the mounting portion.

9. A fastening device, comprising:
the fastening tool according to claim 1; and
at least one of the fastening member and the mounting target object, which is a base member fastened to an installation position of the photovoltaic module.

10. A fastening device, comprising:
the fastening tool according to claim 2; and
at least one of the fastening member and the mounting target object, which is a base member fastened to an installation location of the photovoltaic module.

11. A fastening device, comprising:
the fastening tool according to claim 3; and
at least one of the fastening member and the mounting target object, which is a base member fastened to an installation location of the photovoltaic module.

12. A fastening device, comprising:
the fastening tool according to claim 4; and
at least one of the fastening member and the mounting target object, which is a base member fastened to an installation position of the photovoltaic module.

13. A fastening device, comprising:
the fastening tool according to claim 5; and
at least one of the fastening member and the mounting target object, which is a base member fastened to an installation position of the photovoltaic module.

14. A fastening device, comprising:
the fastening tool according to claim 6; and
at least one of the fastening member and the mounting target object, which is a base member fastened to an installation position of the photovoltaic module.

15. A fastening device, comprising:
the fastening tool according to claim 7; and
at least one of the fastening member and the mounting target object, which is a base member fastened to an installation position of the photovoltaic module.

16. A fastening device, comprising:
the fastening tool according to claim 8; and
at least one of the fastening member and the mounting target object, which is a base member fastened to an installation position of the photovoltaic module.
